(19) United States
(12) Patent Application Publication
(10) Pub. No.: US 2012/0255917 A1
(43) Pub. Date: Oct. 11, 2012

(54) DEVICE FOR CLEANING WASTEWATER

(75) Inventors: Franz Durst, Langensendelbach (DE); Marcus Hoefken, Erlangen (DE)

(73) Assignee: INVENT UMWELT-UND VERFAHRENSTECHNIK AG, Erlangen (DE)

(21) Appl. No.: 13/497,183

(22) PCT Filed: Sep. 23, 2010
(86) PCT No.: PCT/EP2010/064076

§ 371 Date: Jun. 19, 2012

(30) Foreign Application Priority Data
Sep. 23, 2009 (DE) 10 2009 044 918.3

(51) Int. Cl. C02F 1/00

(52) U.S. Cl. 210/787

(57) ABSTRACT

The invention relates to a device for cleaning wastewater, wherein at least one flow channel (S, S1, S2) having at least one horizontal agitator (5) disposed therein in the treatment basin (B), and wherein a cross-sectional surface (Q) of the flow channel (S, S1, S2) extending perpendicularly to the flow direction (SR) increases steadily upstream and downstream from the horizontal agitator (5).

The present invention relates to a device for cleaning wastewater according to the preamble of claim 1.

Such a device is known from DE-OS-1 932 640. A horizontal agitator is disposed in a basin for circulating flow, the propeller of which is enclosed by a pipe piece. The diameter of the propeller corresponds approximately to the diameter of the pipe piece, thereby minimizing losses due to eddies and directing the flow generated by the propeller. Document DE-OS-2 147 080 describes a similar horizontal agitator, in which the propeller is also enclosed by a pipe piece. —The generation of a circulating flow using conventional horizontal agitators requires relatively high energy expenditure.

The object of the invention is to eliminate the disadvantages of the prior art. In particular, a device is to be provided, by way of which a circulating flow can be generated in a treatment basin for cleaning wastewater with reduced energy expenditure. It should be possible to manufacture the device in the simplest and most cost-effective manner possible.

This object is achieved by the features of claim 1. Advantageous embodiments of the invention will be apparent from the features of claims 2 to 8.

According to the invention, the cross-sectional area increases continuously upstream and downstream of the horizontal agitator up to a specified distance from the horizontal agitator, and the increase in the cross-sectional area is formed by a bulge directed into the flow channel, which is provided at at least one wall and/or at the bottom of the flow channel, and the horizontal agitator is disposed in the region of a minimum of the cross-sectional area of the flow channel, which is formed by the at least one bulge. —In contrast to the prior art, the cross-sectional area of the flow channel has a minimum. The horizontal agitator is disposed in this region. It is therefore possible to reduce the energy expenditure required to operate the horizontal agitator in a surprisingly simple and low-cost manner.

It is assumed that the reduction in energy expenditure associated with the device according to the invention is explained as follows: When a horizontal agitator is operated in a conventional flow channel having a cross-sectional area which is constant in the flow direction, a valley forms at the surface of the wastewater above the horizontal agitator due to an eddy generated by the horizontal agitator. Energy is required to generate and maintain this valley in the surface of the wastewater. Now that the cross-sectional area is reduced in the region of the horizontal agitator, the formation of this valley can be prevented. As a result, the energy required to generate and maintain the valley is saved. The size and depth of the valley that forms depend on the geometry of the flow channel and on the rotational speed of the horizontal agitator. A suitable tapering of the cross-sectional area in the region of the horizontal agitator can be adjusted by way of a given geometry of the flow channel and a given rotational speed of the horizontal agitator. The tapering is relatively minor and results from the volume of the valley on the surface of the wastewater to be prevented.

The specified distance up to which the bulge extends upstream and downstream of the horizontal agitator is advantageously equal. The distance is based on the longitudinal extension of the valley. Apart from the cross-sectional area that changes along the distance, the cross-sectional area in the flow channel can otherwise remain constant in a conventional manner.

According to an advantageous embodiment of the invention, at specified operating parameters of the horizontal agitator, a first volume of the bulge(s) which protrude from the at least one wall and/or from the bottom is selected such that a second volume of a valley forming at a surface of the wastewater due to an eddy of the horizontal agitator is equalized. By adjusting the first volume caused by the bulge(s), it is possible to fully equalize a second volume formed by the valley, and to thereby save the maximum amount of energy. The expression “operating parameters of the horizontal agitator” means, in particular, the design of a propeller and the rotational speed thereof.

The two walls, which are opposite each other, each advantageously comprise a bulge, in a symmetrical design.

According to a further embodiment, at least one of the two walls delimiting the flow channel is a flow guide wall provided within the treatment basin. That is, the flow channel can be delimited by a longitudinal wall that delimits the treatment basin and by a flow guide wall provided within the treatment basin. Advantageously, a flow channel comprising at least one horizontal agitator disposed therein is provided on each side of the flow guide wall. In this case, each of the flow channels has the design of the cross-sectional area according to the invention.

The proposed bulges of the wall(s) and/or the bottom(s) can be produced, for example, by suitably shaped laminations or inserts in/at the wall(s) and/or the bottom of the flow channel. Such laminations or inserts can be made of fiber-reinforced plastic, stainless steel sheets, or the like, for example. The first volume is provided by way of the laminations or inserts. —Of course, the flow channel can also be designed for production such that the cross-sectional tapering proposed according to the invention is provided from the start. For example, in the case of a flow channel made of concrete, the walls thereof can be designed from the start such that the tapering of the cross-sectional area according to the invention results.

Exemplary embodiments of the invention will be described in more detail hereafter based on the drawings. In the drawings:

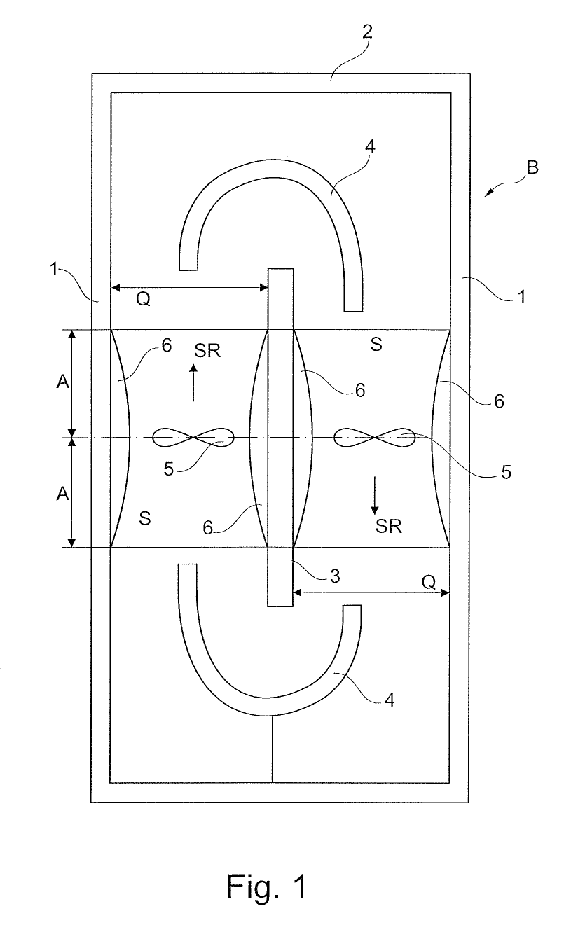

FIG. 1 is a top view of a first device, and

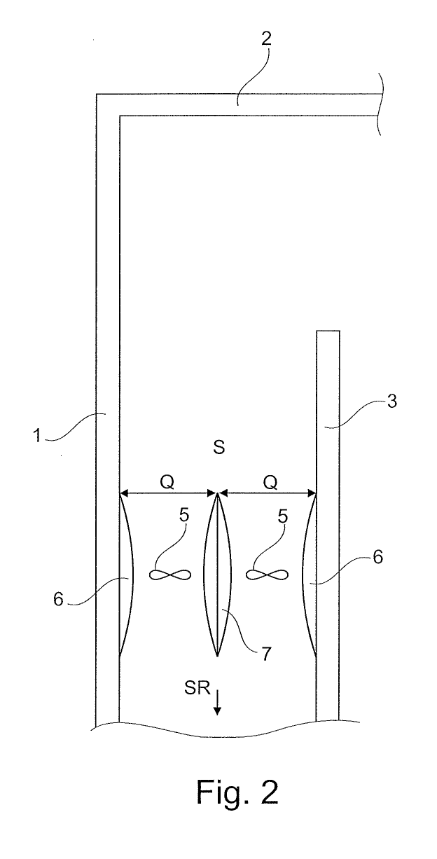

FIG. 2 is a partial top view of a second device.

In the first device, which is shown in FIG. 1, a rectangular treatment basin B is formed of two longitudinal walls 1, which are situated opposite each other, and two transverse walls 2. Located in the treatment basin B is a first flow guide wall 3, which extends substantially parallel to the longitudinal walls 1, and two curved flow guide walls 4 disposed in the region of the ends of the first flow guide wall 3. A flow channel S, in which a horizontal agitator 5 is housed, is formed between the first flow guide wall 3 and each of the longitudinal walls 1. A flow direction SR produced by a propeller of the horizontal agitator 5 extends approximately parallel to the longitudinal extension of the flow channel S. A cross-sectional area of the flow channel S, which is denoted by the reference numeral Q, decreases continuously in the direction of the horizontal agitator 5 starting at a distance A. A minimum of the cross-sectional area Q is located in the region of the horizontal agitator 5. In particular, the propeller of the horizontal agitator 5 is disposed in the region of the minimum of the cross-sectional area Q. As apparent from FIG. 1, the reduction of the cross-sectional area Q is formed by a bulge 6 directed toward the flow channel S, which extends from the longitudinal walls 1 and the first flow guide wall 3. In the present case, the bulges 6 are symmetrical with respect to a middle plane of the flow channel S.

The bulges 6 can be produced, for example, by way of suitably designed laminations which are mounted at the longitudinal walls 1 and the first flow guide wall 3. Inserts can also be provided, which are inserted into recesses provided therefore in the region of the longitudinal walls 1 and/or the flow guide wall 3. Such laminations or inserts can be made of fiberglass-reinforced plastic, stainless steel sheets, or the like, for example.

The function of the first device is as follows:

Wastewater accommodated in the treatment basin B is moved in a circulating manner in the flow direction SR via the action of the horizontal agitators 5. To enable the flow at the outlet of the flow channels S to curve with minimal flow resistance, second flow guide walls 4 are provided in this region. By way of the bulges 6 provided according to the invention, the cross-sectional area Q of the flow channel S is reduced in the region of the horizontal agitator 5. As a result, the horizontal agitator 5 can be operated with reduced energy expenditure.

In the second device, which is shown in FIG. 2, two horizontal agitators 5 are provided in a flow channel S formed between the first flow guide wall 3 and the first longitudinal wall 1. Reference numeral 7 denotes a further flow guide wall, which subdivides the flow channel S into two further flow channels S1, S2. The further flow guide wall 7 is also oriented substantially parallel to the flow direction SR. Bulges 6 are provided at the longitudinal wall 1 and the first flow guide wall 3, the maximum of which is located in the region of the horizontal agitators 5. The further flow guide wall 7 has a contour which is designed substantially as a mirror image of the bulges 6 and therefore each cross-sectional area Q tapers continuously in the region of the further flow channels S1, S2 up to the horizontal agitator 5.

Although the reduction of the cross-sectional area Q in the direction of the horizontal agitator 5 is shown in the exemplary embodiments as formed by bulges 6 at the longitudinal wall 1, the first flow guide wall 3 and/or the further flow guide wall 7, such a reduction of the cross-sectional area Q can also be achieved by other measures. For example, it is possible to provide a saddle-type bulge 6 at a bottom of the treatment basin B, the maximum height of which is located in the region of the horizontal agitator 5.

### LIST OF REFERENCE NUMERALS

1 Longitudinal wall

2 Transverse wall

3 First flow guide wall

4 Second flow guide wall

5 Horizontal agitator

6 Bulge

7 Further flow guide wall

A Distance

B Treatment basin

Q Cross-sectional area

S Flow channel

SR Flow direction

S1, S2 Further flow channel

1-8. (canceled)

9. A method for generating a circulating flow in a treatment basin for cleaning wastewater, wherein at least one circulating flow channel (S, S1, S2), which has a bottom and two walls located opposite each other, is provided in the treatment basin (B), wherein at least one horizontal agitator (5) comprising a propeller is disposed in the flow channel (S, S1, S2), and wherein a cross-sectional area (Q) of the flow channel (S, S1, S2) extending perpendicularly to a flow direction (SR) increases upstream and downstream of the horizontal agitator (5),
wherein the cross-sectional area (Q) increases continuously upstream and downstream of the horizontal agitator (5) up to a specified distance from the horizontal agitator (5),
wherein the increase in the cross-sectional area (Q) is formed by a bulge (6) directed into the flow channel (S, S1, S2), which is provided at at least one wall and/or the bottom of the flow channel (S, S1, S2), and
wherein the horizontal agitator (5) is disposed in the region of a minimum of the cross-sectional area (Q) of the flow channel (S, S1, S2) formed by the at least one bulge (6),
characterized in that
a rotational speed and a design of the propeller are selected such that a second volume of a valley formed at a surface of the wastewater due to an eddy of the horizontal agitator (5) is equalized by a first volume of the bulge(s) (6) protruding from the at least one wall and/or from the bottom.

10. The method according to claim 9, wherein the cross-sectional area (Q) of the flow channel (S, S1, S2) is approximately equal upstream and downstream of the bulge(s) (6).

11. The method according to claim 9, wherein the two walls, which are opposite each other, each comprise a bulge (6) in a symmetrical design.

12. The method according to claim 9, wherein at least one of the walls is a flow guide wall (3, 7) provided within the treatment basin (B).

13. The method according to claim 9, wherein a flow channel (S, S1, S2) having a horizontal agitator (5) disposed therein is provided on either side of the flow guide wall (3, 7).

14. The method according to claim 9, wherein the at least one bulge (6) is produced as one piece with the wall or the bottom.

15. The method according to claim 9, wherein the at least one bulge (6) is formed by a lamination mounted at the wall or the bottom.
